(19) United States
(12) Patent Application Publication
(10) Pub. No.: US 2018/0070586 A1
(43) Pub. Date: Mar. 15, 2018

(54) Encapsulated Biocontrol Agents

(71) Applicant: The Board of Trustees of the University of Illinois, Urbana, IL (US)

(72) Inventors: Kyekyoon KIM, Champaign, IL (US); Hyungsoo CHOI, Champaign, IL (US); In-Yong KIM, Seoul (KR)

(73) Assignee: The Board of Trustees of the University of Illinois, Urbana, IL (US)

(21) Appl. No.: 15/680,590

(22) Filed: Aug. 18, 2017

Related U.S. Application Data
(60) Provisional application No. 62/378,448, filed on Aug. 23, 2016.

(51) Int. Cl. A01N 25/22; A01N 25/34; A01N 63/00; A01N 25/10

(52) U.S. Cl. CPC A01N 25/22; A01N 25/10; A01N 63/00; A01N 25/34

(57) ABSTRACT

Provided is a lyoprotected microcapsule for increasing the survival of a microorganism, such as Pantoea agglomerans E325, after lyophilization and/or storage, which includes an interior core having at least one live microorganism; a first polymer; and at least one nutrient, as well as an exterior shell having second polymer. The lyoprotected microcapsule also includes at least one lyoprotective agent. The polymer may include alginate and the lyoprotective agent may include maltodextrin, trehalose and combinations thereof. Microorganisms within the lyoprotected microcapsules exhibit enhanced survival after lyophilization and/or storage. Also provided are methods for producing such lyoprotected microcapsules and methods for using the lyoprotected microcapsules.

### CROSS-REFERENCE TO RELATED APPLICATIONS

The present application is a U.S. utility patent application claiming priority to pending U.S. Ser. No. 62/378,448, entitled “Encapsulated Biocontrol Agents,” filed Aug. 23, 2016, which is incorporated herein by reference for all that is taught and disclosed.

### STATEMENT REGARDING FEDERALLY SPONSORED RESEARCH OR DEVELOPMENT

This invention was made with government support under AG 2009-51181-06023 awarded by United States Department of Agriculture. The government has certain rights in the invention.

### BACKGROUND OF INVENTION

Fire blight is a destructive disease caused by the pathogen Erwinia amylovora (Ea), and has been a major deterrent to commercial production of apple and pear [1]. The disease was first discovered in New York in 1780 [2] and has since spread worldwide [3, 4]. Streptomycin was initially proved to be an effective antibiotic for controlling fire blight, however, it did not affect the bacterial community structure, but resulted in increased abundance of resistance genes in many production areas [5, 6]. Furthermore, the potential threat of antibiotics to human health is still a subject of ongoing debate [7]. In this context, bacterial biocontrol of the blossom blight phase of fire blight is a promising alternative to antibiotics, which has been demonstrated and subsequently became commercially available [8-10]. In particular, strains of Pantoea agglomerans (Pa) have attracted attention as potential antagonists for fire blight [11-13].

Pa strain E325 (E325), originally discovered by P. L. Pusey, showed excellent efficacy in controlling Ea population on detached crab apple flowers and reducing blossom blight on mature apple trees [14, 15]. The suppressive action of E325 against Ea was proposed as a competition for space and nutrients in apple and pear blossoms and for secretion of a metabolite inhibiting pathogen growth [15]. However, this suppressive action has proved to be inconsistent in orchard trials due to the growth-limiting field conditions such as moisture, available nutrient, temperature, and UV radiation [16, 17]. Moisture is a critical factor in the sequence of events leading to infection, and is closely associated with relative humidity (RH) and temperature [17, 18]. In general, higher RH and lower temperature prolong the moisture of floral organs accelerating bacterial growth, whereas lower RH and higher temperature shorten the period of wet exudates [17]. However, even in arid regions, the pathogen easily reaches maximum populations per flower, which increases the risk of infection through its deposition on the hypanthium where infection generally occurs [10, 19]. Therefore, before widespread invasion of the pathogen, the antagonists must procure the water required for colonizing the hypanthium, even in unfavorable environmental conditions. Work has been performed on microencapsulation and controlled release of E325 for biocontrol of fire blight [20]. This reference demonstrated the effectiveness of water retentivity of alginate microcapsules (AMCs) for maintaining/increasing the populations of encapsulated E325 cells and releasing them to suppress the pathogen strain Ea153 on floral surfaces in moisture-poor environments.

However, there is still a need for an encapsulated microorganism, such as a biocontrol agent, which retains higher levels of viability after a freeze-drying and storage step. Accordingly, it would be desirable to obtain such an encapsulated microorganism demonstrating improved survival of the biocontrol agent, as well as improved efficacy for the biocontrol agent under conditions in the field upon release.

### SUMMARY OF THE INVENTION

In one embodiment, the present invention includes a lyoprotected microcapsule for extending the storage viability of a live microorganism, which includes an interior core comprising at least one live microorganism; a first polymer; and at least one nutrient; an exterior shell comprising a second polymer; and at least one lyoprotective agent; and wherein the live microorganism in the lyoprotected microcapsule has enhanced survival after freeze-drying, as well as extended storage viability compared to a microorganism in a microcapsule in the absence of the at least one lyoprotective agent.

The present invention also includes a method for producing a lyoprotected microcapsule providing extended storage viability for a live microorganism, which includes the steps of encapsulating a live microorganism within an interior core comprising a first polymer and at least one nutrient; where the microcapsule also includes an exterior shell comprising a second polymer to form an encapsulated live microorganism; and contacting the encapsulated live microorganism with a solution comprising a lyoprotective agent to form the lyoprotected microcapsule. The lyoprotected microcapsule provides the microorganism enhanced survival after freeze-drying, as well as extended storage viability, as compared to a microorganism in a microcapsule in the absence of the at least one lyoprotective agent.

The first and second polymer can be independently alginate, ethyl cellulose, polyvinyl alcohol, hyaluronic acid, chitosan, agarose, hydroxypropyl methylcellulose, polyvinyl alcohol copolymer, polyethylene glycol, and gelatin, among others. The microorganism can include Pantoea agglomerans strains C9-1 and E325, Bacillus subtilis BD170, Lactobacillus plantarum strains PC40, PM411, TC54 and TC92, Pantoea fluorescens strain A506, Lactobacillus plantarum SLG17 and Bacillus amyloliquefaciens FNL13, among others. The lyoprotective agent can include one or more of sucrose, glucose, galactose, maltose, maltotriose, maltodextrin, trehalose, mannitol, sorbitol, lactose, glycerol, xylitol, inositol, oligosaccharides, dextrans, and combinations thereof, among others. In some embodiments, the lyoprotective agent is a combination of trehalose and maltodextrin.

In some embodiments, the lyoprotected microcapsules of the invention are formed by a process comprising a microencapsulation technique, such as a vibrational nozzle technique, and the microcapsule has dimensions of between 60 μm and 300 μm. Where the vibrational nozzle technique is used, lyoprotected microcapsules are in part formed by spraying a mixture comprising the microorganism at a concentration of between 0.1×10⁹ and 10×10⁹ cfu/ml, the at least one nutrient, and the polymer, including wherein the polymer comprises alginate at 0.8% to 2.0% (w/v), simultaneously through a vibrational nozzle together with a second alginate solution which has been filtered through a membrane through a second vibrational nozzle. In some embodiments, the alginate solution has been filtered through a 1 to 0.1 micron filter, and the alginate solution is at between about 5% and 0.5% (w/v), and/or wherein the filter is an 0.8 micron, a 0.45 micron, or a 0.22 micron filter, and the alginate solution is 1.0% w/v, 1.2% (w/v), 1.5% (w/v), or 2.0% (w/v). The lyoprotected microcapsule may be hardened by addition of a calcium ion divalent cations or their combinations.

The lyoprotected microcapsules of the invention may be formed by the microencapsulation technique followed by an incubation with at least one lyoprotective agent to form the lyoprotected microcapsule. Thus the lyoprotected microcapsules of the present invention may have been formed by an incubation step with at least one lyoprotective agent. The incubation may be in a solution comprising between about 5% and 30% w/v of the at least one lyoprotective agent, or wherein the solution comprises about 10% trehalose (w/v) and about 10% maltodextrin (w/v). The solution may further comprise sodium chloride, optionally between about 0.1 and 0.3 M. The lyoprotected microcapsule is optionally freeze-dried.

The lyoprotected microcapsules of the invention have the following properties. In one embodiment, after a freeze-drying step, upon rehydration, the microorganisms in the microcapsules exhibit a survival rate of at least about 40%, at least about 80%, or at least about 90%. Alternatively, after a freeze-drying step and 21 days of storage at −20° C., the microorganisms in the lyoprotected microcapsules of the invention exhibit a survival rate of at least about 80%, or, after a freeze-drying step and 42 days of storage at −20 ° C., the microorganisms in the lyoprotected microcapsules of the invention exhibit a survival rate of at least about 60%.

The present invention also includes a method for the treatment or prophylactic prevention of a disease in a plant, the method comprising treating a plant with a therapeutic amount of the lyoprotected microcapsules of the invention. The disease may be a bacterial plant disease, e.g., fire blight, and the plant may be an apple tree or a pear tree.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

The features, objects and advantages other than those set forth above will become more readily apparent when consideration is given to the detailed description below. Such detailed description makes reference to the following drawings, wherein:

FIG. 1. Optical images of the AMCs encapsulating E325 at 25° C. at 0 (immediately after encapsulation), 1, 2 and 3 days.

FIG. 2A. Water retention property of the AMCs 80 μm in diameter,

FIG. 2B. Survival of E325 encapsulated in 18,000 AMCs (2.36×10⁶ CFU) per polystyrene petri dish at 25° C. and 20, 40, 60 and 75% RH. The initial weight of water absorbed in the AMCs was set as 100% water retention. Data are represented as mean ±SD (n=4).

FIG. 3A. Optical images of stigmata, anthers, and hypanthium of an apple flower taken after application of the E325-encapsulating AMCs (Day 0). Arrows indicate the AMCs.

FIG. 3B. Optical image of the flower taken at 3rd day after applying the AMCs at 65% RH. Insets show optical and fluorescence image of the stigma colonization by rfp-E325 released from the AMCs. Scale bar=500 μm.

FIG. 3C. Survival of E325 (E325-naked) and encapsulated E325 (E325-AMC) on detached blossoms of Gala apple at 25° C. and 40, 65 and 90% RH during 72 h. Data are represented as mean ±SD (n=5). At 48 and 72 h, different letters indicate significant differences between groups (p<0.05).

FIGS. 4A, 4B, 4C, 4D. Survival of (FIG. 4A, FIG. 4B) E325 (E325-naked) or encapsulated E325 (E325-AMC) against E153 and (FIG. 4C, FIG. 4D) Ea153 against E325-naked or E325-AMC on detached blossoms of Gala apple under at 65 and 40% RH. As controls, E325-naked, E325-AMC and Ea153 (104 CFU/flower) were separately applied to the flowers. Data are represented as mean ±SD (n=5). *denotes a statistically significant difference between the populations of E325-naked and E325-AMC with E153 or without (FIG. 4A, FIG. 4B) and those of Ea153 with E325-naked or E325-AMC (FIG. 4C, FIG. 4D), *p <0.05, **p<0.005, and ***p<0.001. At 48 or 72 h, different letters indicate statistically significant differences between groups (p<0.05).

FIG. 5A. Effect of trehalose (Tre) and maltodextrin (MD) on the survival of the encapsulated E325 cells in the absence or presence of NaCl during freeze-drying. 20% Tre, 20% MD, or combination of 10% Tre and 10% (w/v) MD in the presence or absence of NaCl were compared.

FIG. 5B. Effect of the combined use of Tre and MD as lyoprotectants on the survival of freeze-dried E325 cells during the storage period of 42 days. The survival of E325-AMCs freeze-dried without any lyoprotectants served as a control. The mean population size that was initially encapsulated was set as 100%. Data are represented as mean ±SD (n=6). *denotes a statistically significant difference as compared to initially encapsulated E325, *p<0.05, **p<0.005, and ***p<0.001. Different letters indicate significant differences between groups (p<0.05). # denotes a statistically significant difference between the populations of E325-AMC freeze-dried in 10% Tre and 10% MD with 0.1 M NaCl and those without, #p<0.05, ##p<0.005, and ###p<0.001.

FIG. 6. Effect of trehalose (Tre) and maltodextrin (MD) on the survival of the encapsulated E325 during freeze-drying. The unit is % (w/v). The population size of the initially encapsulated E325 was set as 100% survival. Data are represented as mean ±SD (n=6). *denotes a statistically significant difference as compared to 100% survival, *p<0.05, **p<0.005, and ***p<0.001. Different letters indicate the least significant difference (p<0.05).

FIG. 7. Effect of the NaCl concentration, used together with 10% trehalose and 10% maltodextrin, on the survival of the encapsulated E325 during freeze-drying. The population size of the initially encapsulated E325 was set as 100% survival. Data are represented as mean ±SD (n=6). *denotes a statistically significant difference as compared to initially encapsulated E325, *p<0.05, **p<0.005, and ***p<0.001. Different letters indicate significant differences between groups (p<0.05).

While the present invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the embodiments above and the claims below. Reference should therefore be made to the embodiments above and claims below for interpreting the scope of the invention.

### DETAILED DESCRIPTION OF THE INVENTION

The compositions and methods now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

Likewise, many modifications and other embodiments of the compositions and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

The present invention relates to a composition comprising a lyoprotected microcapsule for extending the storage viability of a live microorganism. This lyoprotected microcapsule, in broad scope, comprises an interior core which includes at least one live microorganism, a first polymer, and at least one nutrient; as well as an exterior shell comprising a second polymer; and also, at least one lyoprotective agent. Live microorganisms in the lyoprotected microcapsules of the invention have been found to have an extended storage viability compared to microorganisms in a microcapsule in the absence of the at least one lyoprotective agent.

In one embodiment, the present invention relates to lyoprotected microcapsules for the control of a biological pest or disease (e.g. fire blight) comprising a microorganism such as a biocontrol agent (e.g. P. agglomerans strain E325) encapsulated with nutrients in the core of the microcapsule (e.g. 30-300 μm-diameter alginate microcapsules (AMC)), wherein the microcapsule further comprises lyoprotective agents.

In one embodiment, encapsulated microorganisms may include AMC-encapsulated microorganisms. The inventors had found that AMCs prolong the survival of E325 on moisture- and nutrients-poor surfaces for 2 days, even at 20% RH, and consequently allow higher population sizes on the detached apple flowers compared to naked E325. As a result, the AMC system exhibited significantly high suppressive activities against E. amylovora strain E153 on detached apple flowers at 40 and 65% RH. That the AMC-mediated delivery of E325 exhibited high efficacy even at low RH could be attributed to the availability of water and nutrients exclusively to the E325 cells inside the capsules. This indicates that microencapsulation of E325 is a promising approach to the biocontrol of fire blight under arid conditions. The invention further improves upon the microencapsulation of microorganisms, e.g., E325, by introducing lyoprotection to the encapsulated microorganism, e.g., E325 which improved its long-term survivability after lyophilization and/or storage. The present invention shows that encapsulation of such biocontrol agents, together with providing lyoprotective agent(s), is a viable strategy to be applied to plants or soil for the management of fire blight.

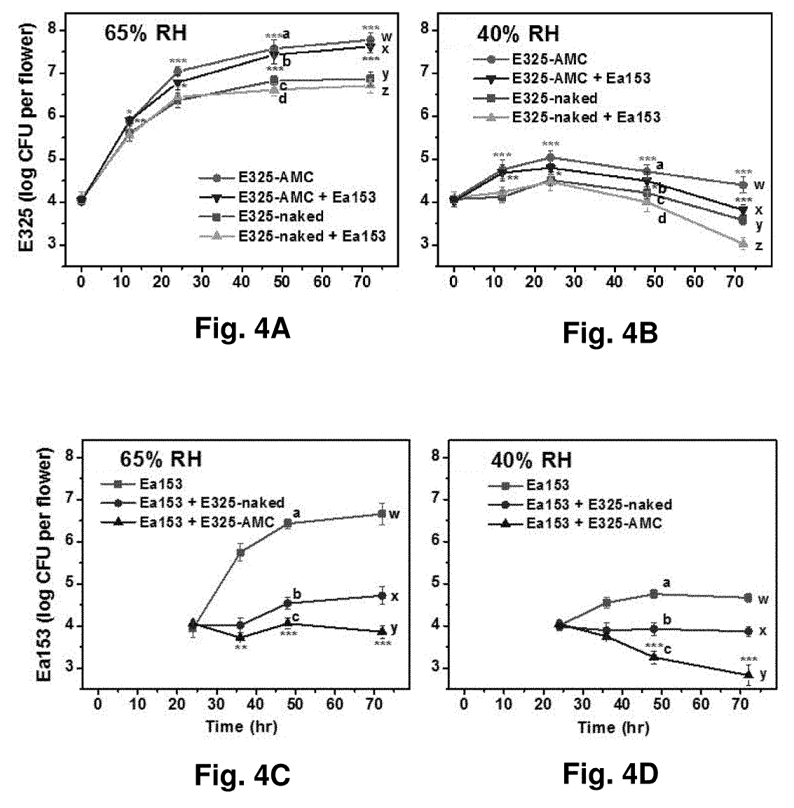

To date, antagonists (e.g., biocontrol agents such as E325) have been applied to flowers targeting the stigmata due to their moisture- and nutrient-rich environment. See, e.g., U.S. Pat. No. 5,919,446, issued Jul. 6, 1999, which is incorporated herein by reference in its entirety for all that is taught and disclosed. Because AMCs provide water and nutrients to antagonists, the AMC-mediated delivery allows targeting the entire floral surfaces, including hypanthium, the main infection site, leading to increased efficacy for preventing Ea invasion. In fact, compared to the naked E325, the encapsulated E325 showed a significantly improved suppressive activity against Ea153 at both 40 and 65% RH (FIG. 4). Under the conditions of poor water availability, both the antagonist E325 and the pathogen Ea153 would compete for moisture outside the AMCs, thus the suppressive effect of naked E325 against Ea153 was minimal at 40% RH. Still, at 40% RH the encapsulated E325 exhibited a rather remarkable suppressive effect. Furthermore, due to the prolonged survival of the encapsulated antagonists, their chance to be transferred to late-blooming or nearby flowers via rain or arthropods may increase.

Lyoprotection is a feature of the present invention because storage of microcapsules comprising a biocontrol agent such as a microorganism is desirable for a commercial product. Maintaining the viability of an encapsulated biocontrol agent prior to use, e.g., during freeze-drying and/or storage is an important consideration for commercial products.

Therefore, the present invention includes a method for producing a lyoprotected microcapsule providing increased survival after lyophilization and/or extended storage viability for a live microorganism, comprising the following steps. The method includes encapsulating a live microorganism within an interior core comprising a first polymer and at least one nutrient; further comprising an exterior shell comprising a second polymer to form an encapsulated live microorganism. The method also includes contacting the encapsulated live microorganism with a solution comprising a lyoprotective agent to form the lyoprotected microcapsule. The lyoprotected microcapsule provided by this method supplies the microorganism with increased survival after lyophilization and/or extended storage viability compared to a microorganism in a microcapsule in the absence of the at least one lyoprotective agent.

Thus, in one aspect, the present invention provides a method for producing a lyoprotected microcapsule, and a lyoprotected microcapsule, which provides e.g. increased survival after lyophilization and/or extended storage viability for a live microorganism or live cell. The methods and devices of the present invention which provide increased survival after lyophilization and/or extended storage viability for cells or microorganisms are useful for all applications in which live cells or microorganisms are used. Such applications include biocontrol, probiotics, stem cells, and the like. Methods, compositions, and uses of the instant invention are described in more detail hereinbelow.

The word “cell” or “microorganism” used herein can refer to either or both to a cell or a microorganism. Cells can be defined as the smallest structural and functional unit of an organism, typically microscopic and consisting of cytoplasm and a nucleus enclosed in a membrane. There are two distinct types of cells: prokaryotic cells (e.g. bacterial cells) and eukaryotic cells (e.g. plant, fungal or animal cell). A well-defined nucleus surrounded by a membranous nuclear envelope is present only in eukaryotic cells. Cells can include animal, plant and fungal cells, including those in tissue culture. Microscopic organisms typically consist of a single cell, which is either eukaryotic or prokaryotic. Microorganisms can include bacteria, protozoans, and certain algae and fungi.

In one embodiment, a microorganism or cell treated by the methods of the invention to form microcapsules may be used as a biocontrol agent to treat or prophylactically prevent disease. Therefore the invention includes a method to treat or prophylactically prevent a disease in a subject, including wherein the subject is a plant, the method comprising treating the subject with a therapeutic amount of the lyoprotected microcapsules according to the invention. The biocontrol agents contemplated for use herein include, without limitation, all bacteria, fungi, yeasts, viruses, microsporidians, protozoa, nematodes and other such organisms that are pathogenic toward target pests. Any component of the organism or stage of its life cycle which is infective to the host upon contact or ingestion is considered to be within the scope of the disclosure. For instance, in the case of Bacillus thuringiensis, (“B.t.”), the vegetative cells, spores, and proteinaceous crystals are all effective in directly or indirectly killing host insects susceptible to B.t. It is also known that naturally occurring and synthetic vectors such as plasmids, phages, and various DNA/RNA constructs have potential for functionally modifying higher organisms, and therefore are also included herein as being within the scope of the term “biocontrol agent.”

Examples of other agronomically important pest pathogens without limitation thereto include: other entomopathogenic bacteria such as B. sphaericus, and B. popillae; plant pathogenic bacteria, such as Pseudomonas spp. and Agrobacterium; plant pathogenic fungi, such as Sclerotinia, Rhizoctonia, Fusarium, Alternaria, Colletotrichum, and Sclerotium; entomopathogenic fungi, such as Pandora, Beauveria and Conidiobolus and the yeasts; entomopathogenic viruses, such as Autographa californica nuclear polyhedrosis virus, and Heliothis spp. virus; microsporidians such as Vairimorpha necatrix and Nosema locustae, as well as the nematode Steinernema carpocapsae and the gall-forming nematode Subanguina picridis, Pantoea agglomerans, Pantoea fluorescence, and Lactobacillus plantarum. Combinations of biocontrol agents could also be used.

In one embodiment the biocontrol agent is Pantoea agglomerans strain E325 and C9-1, which is effective at controlling Erwinia amylovora (Ea) population, the cause of the destructive diseases Fire blight, a major deterrent to commercial production of apple, pear. Example microorganisms which are useful for biocontrol and may be used in the present invention include, therefore, for example, Pantoea agglomerans strains, such as strains C9-1 and E325, Bacillus subtilis such as strain BD170, Lactobacillus plantarum strains such as PC40, PM411, TC54 and TC92, P. fluorescens such as strain A506, Lactobacillus plantarum such as strain SLG17 and Bacillus amyloliquefaciens such as strain FNL13. Other microorganisms known for biocontrol purposes, without limitation, may be used in the present invention.

The amount of the biocontrol agent present in the microcapsule will depend on many factors, including the particular biocontrol agent, the target disease, the plant type, and the environmental conditions. One of ordinary skill in the art can determine the amount of biocontrol agent depending on the circumstances, or by using routine experimentation.

The biocontrol agents of the disclosure are normally propagated by cultivation in a suitable aqueous medium and then recovered as a concentrated suspension of the biocontrol agent. The microcapsules can further comprise nutrients suitable for the particular biocontrol agent, for example, luria broth (LB) for E325.

In another embodiment, a microorganism or cell treated by the methods of the invention to form microcapsules may be used as a probiotic to treat or prophylactically prevent disease. Therefore the invention includes a method to treat or prophylactically prevent a disease in a subject, including wherein the subject is a human or an animal, the method comprising treating the subject with a therapeutic amount of the lyoprotected microcapsules according to the invention. A disease prevented by or treated by probiotic bacteria include gastrointestinal disorders, such as gastric ulcers, inflammatory bowel disease, acidic gut syndrome, gastritis, food allergies, and lactose intolerance.

A definition of a probiotic is a live micro-organisms which, when administered in adequate amounts, confer a health benefit on the host. Probiotics have to be alive when administered, showing the benefit for methods of the invention for enhancing survival and storage of live microorganisms. Probiotic organisms include specific strains of the following genera: Lactobacillus, Bifidobacterium, Saccharomyces, Enterococcus, Streptococcus, Pediococcus, Leuconostoc, Bacillus, Escherichia coli. Non-limiting examples include, but are not limited to Saccharomyces cereviseae, Saccharomyces bayanus, Saccharomyces boulardii, Bacillus coagulans, Bacillus licheniformis, Bacillus subtilis, Bifidobacterium angulatum, Bifidobacterium animalis, Bifidobacterium bifidum, Bifidobacterium breve, Bifidobacterium infantis, Bifidobacterium lactis, Bifidobacterium longum, Enterococcus durans, Enterococcus faecium, Enterococcus faecalis, Escherichia coli Nissle 1917, Lactobacillus acidophilus, Lactobacillus amylovorus, Lactobacillus alimentarius, Lactobacillus brevis; Lactobacillus bulgaricus, Lactobacillus casei subsp. casei, Lactobacillus casei Shirota, Lactobacillus curvatus, Lactobacillus delbrueckii subsp. lactis, Lactobacillus fermentum, Lactobacillus farciminus, Lactobacillus gasseri, Lactobacillus helveticus, Lactobacillus johnsonii, Lactobacillus lacti, Lactobacillus paracasei, Lactobacillus pentosaceus, Lactobacillus plantarum, Lactobacillus reuteri, Lactobacillus rhamnosus (Lactobacillus GG), Lactobacillus sake, Lactobacillus salivarius, Lactobacillus thermotolerans, Lactobacillus mucosae, Lactococcus lactis, Micrococcus varians, Pediococcus acidilactici, Pediococcus pentosaceus, Pediococcus acidilactici, Pediococcus halophilus, Streptococcus faecalis, Streptococcus thermophilus, Staphylococcus carnosus, Staphylococcus xylosus and any mixture of these cells.

In another embodiment, the microorganism may be a therapeutically engineered cell and/or stem cell. Encapsulation of these cells may help to provide a physical barrier to protect the cells from hostile extrinsic factors and significantly improve the therapeutic efficacy of transplanted stem cells in different models of disease, such as cancer. Methods and microcapsules of the present invention may also be useful for developing stable encapsulated vaccines, stable encapsulated protein therapeutics, and DNA encapsulation.

The lyoprotected microcapsules of the present invention may be made by the methods of the present invention. The present methods can include the step of encapsulating a live microorganism or live cell. Specifically, the encapsulated live microorganism may be encapsulated by one of any number of a variety of encapsulation techniques. Encapsulation techniques for microorganisms and cells are generally known in the art. Such encapsulation techniques include combinations of phase separation or precipitation, emulsion/solvent evaporation, and/or spraying methods. Variations of the fabrication parameters during the encapsulation technique, as known in the art, generally allow control of the particle size and size distribution.

Encapsulation techniques for encapsulating a live microorganism include a physicochemical or mechanical process to entrap the microorganism in a material in order to produce particles with diameters of a few nanometers to a few millimeters. Thus microcapsules are small particles that contain an active agent or core material surrounded by a coating or shell. In one embodiment a microcapsule of the invention is a small sphere with a uniform wall around it. The material inside the microcapsule is referred to as the core, internal phase, or fill, whereas the wall is sometimes called a shell, coating, or membrane. Some materials like lipids and polymers, such as alginate, may be used as a mixture to trap the material of interest inside the core.

A variety of encapsulation techniques are known in the art and can be used in the instant invention. Briefly, encapsulation techniques include pan coating, where the cores are tumbled in a pan while the coating is applied, or air coating, where a solid particulate core is dispersed into an airstream and coated with polymers in a volatile solvent. Encapsulation techniques also include wherein liquids may be encapsulated by using a rotating extrusion head containing concentric nozzles with a jet of core liquid surrounded by a sheath of shell solution; as the jet moves through the air it breaks and is coated with the shell solution. Encapsulation techniques also include use of vibrational nozzle techniques which include using a laminar flow through a nozzle with vibration of the nozzle or liquid in resonance with Rayleigh instability to break the stream into individual microparticles.

In one embodiment, the encapsulated live microorganisms of the invention may be created by an encapsulation technique comprising a microsphere fabrication technology which combines two techniques for generating monodisperse microspheres with precisely controlled sizes. This precision particle fabrication (PPF) technology also allows fabrication of predefined particle size distributions via continuous variation of the process parameters. Such a technique is disclosed in, for example, U.S. Pat. No. 8,293,271, issued Jun. 9, 2009, and U.S. Pat. No. 8,663,511, issued Mar. 4, 2014, both entitled “Encapsulated materials and methods for encapsulating materials,” inventors Kim, Kyekyoon and Choi, Hyungsoo, which are incorporated by reference herein in their entireties for all that is taught and disclosed. U.S. Pat. Nos. 8,663,511 and 8,293,271 both teach a system which provides a method for applying a force to an inner stream, an outer stream or both of a combined stream to produce of plurality of capsules (e.g., microcapsules). The method generally comprises spraying a polymer-containing solution through a nozzle with (i) acoustic excitation to produce uniform droplets and (ii) an annular, non-solvent carrier stream allowing further control of the droplet size. The apparatus for carrying out the method is designed to pass a solution carrying the core material, along with the microorganisms, through a small nozzle or other orifice (20 μm to a few mm in diameter) to form a smooth, cylindrical jet. The nozzle is vibrated by a piezoelectric transducer driven by a wave generator at a frequency tuned to match the flow rate and desired drop size. The acoustic wave along the liquid jet generates periodic instabilities which in turn, break the stream into a train of uniform droplets.

To fabricate uniform core-shell microcapsules (e.g., encapsulated microorganisms) having a predefined diameter and a shell thickness, a double-emulsion approach is taken by allowing the discontinuous phase of the primary emulsion to coalesce and form the core of the particle and then coating the preformed microparticles with a second material. “Double-wall” particles comprising polymer cores and shells can be formed by controlling phase separation of the two sphere-forming materials. In one embodiment, a precision core-shell microparticle fabrication technique may be used as described in U.S. Pat. No. 8,663,511 or U.S. Pat. No. 8,293,271 discussed above, and incorporated by reference herein in its entirety. Briefly, in this method, for example, utilizes an apparatus which is designed having an outer nozzle operable to discharge an outer stream and an inner nozzle placed within the outer nozzle operable to discharge an inner stream, which are acoustically excited to break up into uniform core-shell droplets.

Another factor for the encapsulated live microorganisms of the present invention is the release profiles of the eventual lyoprotected microcapsules. The encapsulated cells must be confined safely within the capsules, maintaining their viability and activity until the time of release; protected from adverse environmental conditions, such as low moisture and UV radiation during application and initial establishment, and protected from other agents.

As known in the art, the encapsulation and eventual release of “payload” of the microcapsule may be determined an array of factors including the type of polymer, the polymer molecular weight, the copolymer composition, the nature of any excipients added to the microsphere formulation (e.g., for stabilization of the therapeutics), and the microsphere size. The type of polymer used in microsphere fabrication and the way in which the polymer degrades affect release rate. A surface eroding type of polymer is relatively hydrophobic and joined by labile bonds so although they resist entry of water into the interior of the particle they degrade into oligomers and monomers primarily at the surface. Bulk-eroding polymers, such as PLG, readily allow permeation of water into the polymer matrix and degrade throughout the microsphere matrix. Polymer molecular weight can affect polymer degradation and drug release rates. Increase in molecular weight decreases diffusivity and therefore release rates. Diffusion through water-filled pores occurs as polymer degradation generates soluble monomers and oligomers that can diffuse out of the particle. These small products are formed more quickly upon degradation of lower molecular weight polymers.

The size of the microcapsule will also affect rate of release, since as size decreases, surface to volume ratio of the particles increases allowing for greater flux from the particle. Water penetration will occur more quickly due to the shorter distance into the center of the particle.

For use in protecting from fireblight, the duration for blossoms to be receptive to microbial colonization is typically 3-4 days, so the microorganisms must be delivered within this time period. In one embodiment, alginate is used to generate core-shell structures. Generally, as described in more detail in the examples, alginate solutions provided from two separate syringe pumps were combined into a coaxial jet configuration using a coaxial nozzle. The resulting coaxial jet, with different properties, was subsequently broken up into a train of uniform core-shell droplets by acoustic excitation at a rate of approximately 1000-4000 drops/s. Relative flow rates of the two coaxial jet streams (the inner jet stream forming the inner core and the outer jet stream forming the exterior shell) were varied to control the core diameter and shell thickness of the core-shell microcapsules, thus the overall capsule size. Once uniform core-shell droplets (e.g., encapsulated microorganisms) were formed, they were hardened by divalent cations (e.g., Ca²⁺). Size control for release of the E325 from the microcapsules. Size, by optical micrograph, of 120 μm and 300 μm was produced from 2% alginate solution for the shell and 1% alginate containing E325 and LB broth for the core. The smaller microcapsules are more likely to maintain cell viability due to lower resistance to transport of oxygen, nutrients, and metabolites, and possess greater mechanical strength and higher biocompatibility. Drying the capsules produces irregular surfaces and decreases the volume to approximately 62%, which is restored upon re-hydration and re-swelling.

In the instant invention, the microcapsules of the instant invention may be formed such that they are between about 40 μm and about 5,000 μm, between about 60 μm and 500 μm, or between about 60 μm and about 300 μm.

The interior core may be formed by forming a solution comprising the microorganism or cell, the nutrient, and the polymer. In one embodiment, the microorganism in the solution is at a concentration of between 0.01×10⁹ and 100×10⁹ cfu/ml, although the amount used will vary based on the concentrations and amounts of the other ingredient. A single microorganism can occur per microcapsule, or “clusters” or more than one microorganism can occur per microcapsule, depending on what is desired. In one embodiment the concentration of the microorganism is between about 0.1×10⁹ and 10×10⁹ cfu/ml, between about 0.5×10⁹ and 5×10⁹ cfu/ml, or about 1.6×10⁹ cfu/ml.

Polymers for use in the instant invention (for the first polymer and the second polymer) may include any number of polymers known in the art, including polymers that are capable of forming hydrogels. Such polymers include polysaccharides such as alginate, cellulose, cellulose derivatives such as ethyl cellulose, hydroxypropyl methylcellulose and the like; hyaluronic acid, chitosan, agarose; polyethers such as polyethylene glycol, polypropylene glycol and copolymers such as polylysine, polycaprolactone, polylactide and the like; poly(a-hydroxy esters) such as poly(L-lactic-co-glycolic acid), poly(c-caprolactone), poly(NiPAAm), poly(vinyl alcohol); polyvinyl alcohol copolymers (such as with acrylate or methacrylate); polyurethane and the like; and proteins such as collagen, fibrin glue, and gelatin.

Alginate is a well-known example of a polymer useful for the encapsulated microorganisms and lyoprotected microcapsules of the present invention. It is a polysaccharide with mannuronic and glucuronic acid residues and can be crosslinked by calcium ions. Crosslinking can be carried out at room temperature and physiological pH. Alginates may also include modified alginate-starch polymer, alginate-inulin-xanthan gum, alginate and poly L-lysine polymer a chitosan/alginate polymer and a chitosan/xanthan polymer. Numerous examples of such alginate encapsulation materials are disclosed in, e.g., International patent application WO 2012/101167 which is incorporated herein by reference its entirety for all that is taught and disclosed.

The concentration of polymer in the solution may be optimized for the particular application.

In one embodiment of the instant invention, the polymer is alginate. As stated above, alginate may be advantageously hardened by crosslinking after formation of the particles by treatment with divalent ion, such as calcium ion. Such a gel formation occurs mainly at the junctions between ions and homopolymeric blocks of glucuronic acid. Since calcium-alginate gel produced through this process has bridges formed by ion bond, it can make hard hydrogel. Alginate gel can be prepared in aqueous solutions and also swelled and gradually biodegraded.

When alginate is used as the first and the second polymer, alginate may be used at concentrations independently between about 0.1% (w/v) and 10% (w/v), between about 0.5% (w/v) and 5% (w/v), at about between about 0.8% to 2.0% (w/v). The concentrations of alginate in the core solution and the exterior shell solution may differ from one another to form a shell having differential properties from the core. For example, the shell solution may be between 1 and 2% alginate and the core solution may be about 1% alginate. The porosity of the alginate used for the present invention may be controlled and made consistent by filtering the alginate through a filter, such as 1 to 0.1 micron filter. Typical pore sizes for filtration of the alginate are 0.8 micron, a 0.45 micron, or a 0.22 micron filter.

Optionally, a solution comprising alginate may comprise further polymers, water-soluble filler or gel extender such as, for example, a 0-30% aqueous solution of a polysaccharide such as dextran. Other suitable filler materials include sodium carboxy methyl cellulose, methyl cellulose, dextrins, and some soluble starches.

The nutrient, in some embodiments, is any nutrient or combination of nutrients such as a commercially available nutrient broth that supports the growth of the particular microorganisms or cells used in the invention. Nutrient broths are widely commercially available. In some embodiments the nutrient is a liquid nutrient broth. Suitable for the present invention is Luria-Bertani (LB) broth containing tryptone, yeast extract and sodium chloride. Broths may be used at 0.1× to 10× concentration in the core solution. Most commonly broths will be used at 1× concentration in the core solution.

The exterior shell, in some embodiments, may be formed by preparing a solution comprising the polymer. The polymer and concentrations of the polymer may be prepared in accordance with the guidelines above set out for the interior core, with the difference that the exterior shell will in many embodiments have a higher concentration of polymer (w/v) than the interior core.

In one embodiment, the lyoprotected microcapsules and the encapsulated microorganisms of the present invention may include wherein the first and second polymer are independently alginate, ethyl cellulose, polyvinyl alcohol, hyaluronic acid, chitosan, agarose, hydroxypropyl methylcellulose, polyvinyl alcohol copolymer, polyethylene glycol, or gelatin, or wherein the first polymer and the second polymer are alginate; wherein the microorganism is Pantoea agglomerans strains C9-1 and E325, Bacillus subtilis BD170, Lactobacillus plantarum strains PC40, PM411, TC54 and TC92, P. fluorescens strain A506, Lactobacillus plantarum SLG17 or Bacillus amyloliquefaciens FNL13; or wherein the microorganism is P. agglomerans strain E325.

In another embodiment, the lyoprotected microcapsules and the encapsulated microorganisms of the present invention may include wherein the microcapsule is formed by a process comprising a microencapsulation technique and the microcapsule has dimensions of between 60 μm and 300 μm, and wherein the microencapsulation technique is a vibrational nozzle technique.

In another embodiment, the lyoprotected microcapsules and the encapsulated microorganisms of the present invention may include wherein the interior core is formed by spraying a mixture comprising the microorganism at a concentration of between 0.1×10⁹ and 10×10⁹ cfu/ml, the at least one nutrient, and the polymer, wherein the polymer comprises alginate at 0.8% to 2.0% (w/v), through a vibrational nozzle.

In another embodiment, the lyoprotected microcapsules and the encapsulated microorganisms of the present invention may include wherein the exterior shell is formed by simultaneously spraying an alginate solution which has been filtered through a membrane through a vibrational nozzle. In some embodiments, the alginate solution has been filtered through a 1 to 0.1 micron filter, and the alginate solution is at between about 5% and 0.5% (w/v). In other embodiments, the lyoprotected microcapsule of claim 12, wherein the filter is selected from a 0.8 micron, a 0.45 micron, or a 0.22 micron filter, and the alginate solution is 1.0% (w/v), 1.2% (w/v), 1.5% (w/v), or 2.0% (w/v).

In another embodiment, the lyoprotected microcapsules and the encapsulated microorganisms of the present invention may include wherein the polymer of the encapsulated microorganism is hardened by addition of a divalent cation such as calcium ion, or a combination thereof, by methods known in the art.

As discussed hereinabove, encapsulated microorganisms in the absence of lyoprotective agent(s) exhibit reduced viability and/or survival after a drying, freeze-drying, and/or storage step. Thus, the present invention also includes lyoprotected microcapsules and method for making lyoprotected microcapsules which provide for improved survivability after drying, freeze drying as well as, or in addition to, improved survivability upon extended storage. The lypoprotected microcapsules and methods for making same also exhibit acceptable rehydration characteristics and release characteristics for their particular application, for example, in the field.

Therefore the methods of the instant invention also include the step of contacting the encapsulated live microorganism with a solution comprising at least one lyoprotective agent to form the lyoprotected microcapsule. The lyoprotected microcapsule can provide the microorganism with improved survivability after drying, or freeze drying as well as, or in addition to, improved survivability upon extended storage compared to a microorganism in a microcapsule in the absence of the at least one lyoprotective agent. The invention also provides lyoprotected microcapsules formed by a microencapsulation technique followed by an incubation with the at least one lyoprotective agent to form the lyoprotected microcapsule.

Observed survival of non-encapsulated biocontrol agents is often very low, for example, less than 5% for some bacteria. Encapsulation of E325 demonstrated improved survivability by providing a physical barrier against low relative humidity conditions, denoting improved survivability against other harsh environmental conditions such as freezing, loss of cellular turgor, and vacuum stress [30-32]. However, when encapsulated E325 microorganisms produced by methods of the present invention but in the absence of lyoprotectants were lyophilized, the survival of the E325 cells was reduced to about 28%. As noted hereinabove, the ability to produce and store an encapsulated microorganism or cell prior to an intentional release is highly desired for commercial production of such materials.

Thus, the present invention further provides methods for production and compositions comprising lyoprotected microcapsule comprising microorganisms. In the present invention, the inventors demonstrated that the viability of encapsulated E325 was significantly enhanced after freeze-drying by employing lyoprotective agents in the encapsulated E325 to form lyoprotected microcapsules. The present inventors found survival rates increased to greater than 80% by particular embodiments of the invention, e.g., combinations of trehalose and maltodextrin.

Thus, in one embodiment, the instant invention comprises contacting the encapsulated live microorganism with a solution comprising at least one lyoprotective agent to form the lyoprotected microcapsule. The invention thus includes lyoprotected microcapsules wherein the microencapsulation technique is followed by an incubation with the at least one lyoprotective agent to form the lyoprotected microcapsule.

The encapsulated cells are incubated in an incubation solution containing at least one lyoprotectant over a suitable period of time. The inventors have found this method provides a protective effect on the (structural) integrity of capsules (the encapsulation material) both before and during the freeze-drying process. In addition, the shelf-life of the capsules with the cells encapsulated therein is extended and the viability of the encapsulated cells is significantly increased (cf. Example Section).

In the method of the invention any suitable number of contacting step(s) of the encapsulated microcapsules with the lyoprotective agent(s) can be carried as long as the number is sufficient to provide a desired effect on, for example, the viability of the encapsulated cells after the freeze-drying. A contacting step may also be called “incubation” herein. In illustrative embodiments the method comprises 1, 2, 3, 4, 5, 6, 7, 8, 9 or 10 incubation steps. A suitable incubation time as well as a suitable the number of incubation steps can be determined empirically, for example, by assessing the viability of the encapsulated cells after freeze-drying followed by (after a certain time period) re-hydrating of the cells. In some embodiments the incubation time is typically about several minutes to about several hours per incubation step, for example, for about 10 minutes. The incubation can be carried out either without agitation but also under agitation (such as, for instance, shaking or rolling) to improve the uptake of the lyoprotectant by the encapsulated microorganisms.

A lyoprotectant can be defined as a substance that is added to a formulation in order to protect the active ingredients upon lyophilization. Lyoprotection can be defined as the stabilization and prevention of the degradation of a macromolecule such as a microorganism or cell, both during freeze-drying and/or during subsequent storage. A number of compounds are known as lyoprotectants of microorganisms, such as glycols (ethylene glycol or propylene glycol), skim milk, glycerol, dimethylsulfoxide (DMSO), formamide, a mixture of formamide and DMSO, N-methylacetamide (MA), polyvinylpyrrolidone, propanediol (either 1,2-propanediol or 1,3-propanediol or a mixture of both), serum albumin, a carbohydrate and alginate. Examples of alginates that can be used as lyoprotectant include Satialgine® alginate or Algogel® alginate that are both available from Cargill. Examples of carbohydrates that can be used as lyoprotectant include, but are not limited to sucrose, glucose mixed with lactose, trehalose, raffinose, dextran, pectin. Other lyoprotectants include polyhydroxy compounds such as sugars (mono-, di-, and polysaccharides), polyalcohols, and their derivatives, such as trehalose and sucrose. Trehalose is produced by a variety of plant (for example Arabidopsis thaliana), fungi, and invertebrate animals that remain in a state of suspended animation during periods of drought (also known as anhydrobiosis).

Therefore, in one embodiment, the lyoprotective agent includes sucrose, glucose, galactose, maltose, maltotriose, maltodextrin, trehalose, mannitol, sorbitol, lactose, glycerol, xylitol, inositol, oligosaccharides, dextrans, and combinations thereof.

In one embodiment, the lyoprotectant(s) of the present invention can comprise solutions comprising maltodextrin, trehalose, or a combination of maltodextrin and trehalose. In some embodiments, the solution further comprises a salt, such as sodium chloride.

Solutions comprising lyoprotectants may comprise between about 0.1% and 50%, w/v, of an individual lyoprotectant; between about 1% and 40%, w/v of individual lyoprotectant; between about 5% and 35% w/v of individual cryoprotectant; or between about 10% and 20% w/v of individual lyoprotectant. Alternatively the lyoprotectant can be between about 5% and 15%, w/v, of an individual lyoprotectant; between about 8% and 12%, w/v of individual lyoprotectant; between about 15% and 25% w/v of individual lyoprotectant; or between about 18: and 22% w/v of individual lyoprotectant.

In one embodiment, the lyoprotectant solution may comprise maltodextrin or trehalose, wherein the maltodextrin or trehalose is used at between about at between about 15% and 25% w/v; between about 18% and 22% w/v, or about 20% w/v. Alternatively the lyoprotectant may comprise both maltodextrin and trehalose wherein each is used at between about 5% and 15%, w/v, between about 8% and 12%, w/v of individual lyoprotectant, or about 10% w/v.

The solution comprising lyoprotectant may further comprise a salt such as sodium chloride. Sodium chloride solutions may be between about 0.01 M and 1 M, or between about 0.05 M and 0.5 M, or between about 0.1 M and 0.3 M, or about between 0.15 and 0.25 M. Alternatively sodium chloride solutions may comprise between about 0.02 and 0.25 M, between about 0.05 and 0.2 M, between about 0.7 M and 0.15 M, between about 0.8 and 0.13 M, between about 0.9 and 0.12 M, or about 0.1 M.

In one embodiment, solutions may comprise maltodextrin or trehalose at between about at between about 15% and 25% w/v; between about 18% and 22% w/v, or about 20% w/v, together with NaCl of between about 0.05 and 0.2 M, between about 0.7 M and 0.15 M, between about 0.8 and 0.13 M, between about 0.9 and 0.12 M, or about 0.1 M. In another embodiment, solutions may comprise both maltodextrin and trehalose at between about 5% and 15%, w/v, between about 8% and 12%, w/v of individual lyoprotectant, or about 10% w/v, together with NaCl of between about 0.05 and 0.2 M, between about 0.7 M and 0.15 M, between about 0.8 and 0.13 M, between about 0.9 and 0.12 M, or about 0.1 M.

Without being bound by theory, the inventors believe the surprisingly successful increase in survivability to lyophilization and/or storage is due to a combination effect where trehalose prevents cellular collapse caused by intracellular ice crystals formed during freezing and maltodextrin promotes the egress of water molecules, causing intracellular accumulation of trehalose. Use of sodium chloride, despite reports that it promotes the intracellular accumulation of osmolytes, did not show statistical improvedment in survival after lyophilization but showed improved long term storage of the lyophilized microcapsules.

In some embodiments, the method further comprises lyophilization of the lyoprotected microcapsule and subsequent storage of the lyophilized, lyoprotected microcapsule. Therefore the present invention optionally includes a step of freeze-drying the encapsulated microorganisms. Technically, freeze-drying, also known as lyophilisation, lyophilization, or cryodesiccation, can be defined as cooling of liquid sample, resulting in the conversion of freeze-able solution into ice, crystallization of crystallizable solutes and the formation of an amorphous matrix comprising non-crystallizing solutes associated with unfrozen mixture, followed by evaporation (sublimation) of water from amorphous matrix. The evaporation (sublimation) of the frozen water in the material is usually carried out by reducing the surrounding pressure to allow the frozen water in the material to sublimate directly from the solid phase to the gas phase.

The freezing step includes any method that is suitable for freezing of the encapsulated cells. On a small scale, for example, in a laboratory, freezing may be done by placing the material in a freeze-drying flask and rotating the flask in a bath, also known as a shell freezer, which is cooled by, for example, mechanical refrigeration, by a mixture of dry ice with an alcohol such as methanol or ethanol, or by liquid nitrogen. It is of course also possible to use a commercially available freeze-dry apparatus such as Thermo Scientific® Modulyo Freeze-Dry System distributed by Thermo Fisher Scientific Inc. On a larger scale, freezing is generally using a commercial, temperature controlled freeze-drying machine. When freezing the encapsulated cells, the freezing is generally carried out rapidly, in order to avoid the formation of ice crystals. Usually, the freezing temperatures are between −50° C. and −80° C. The next step is the primary drying. During the primary drying phase, the pressure is lowered (typically to the range of a few millibars), and sufficient heat is supplied to the material for the water to sublime. The amount of heat necessary can be calculated using the sublimating molecules' latent heat of sublimation. In this initial drying phase, about 95% of the water in the material is sublimated. This phase may be slow (can be several days in the industry), because, if too much heat is added, the material's structure could be altered. Secondary drying can follow as the last step in freeze drying. The secondary drying phase aims to remove, if present, unfrozen water molecules, since the ice was removed in the primary drying phase. In this phase, the temperature is usually higher than in the primary drying phase, and can even be above 0° C., to break any physico-chemical interactions that have formed between the water molecules and the frozen material. Usually the pressure is also lowered in this stage to encourage desorption (typically in the range of microbars, or fractions of a pascal). After the freeze-drying process is complete, the vacuum is usually broken with an inert gas, such as nitrogen, before the freeze-dried encapsulated cells are packaged and/or stored for the further use.

The lyoprotected microcapsules of the present invention allow for freeze-drying of the microcapsule, while maintaining the efficacy of the biocontrol agent. Combined with the ability to control the release of the biocontrol agent via the capsule, and access entire floral surfaces, the compositions and methods of the invention allow for improved storage, stability, efficacy and prolonged activity of the biocontrol agent.

Therefore, in one embodiment, the methods for making lyoprotected microcapsules of the invention, and the lyoprotected microcapsules comprising microorganisms of the present invention, are capable of providing increased survival after lyophilization and/or increased survival following lyophilization and storage. For example, following a freeze-drying step, upon rehydration, microorganisms encapsulated within lyoprotected microcapsules of the present invention exhibit a survival rate of at least about 30%; at least about 35%; at least about 40%; at least about 45%; at least about 50%; at least about 55%; at least about 60%; at least about 65%; at least about 70%; at least about 75%; at least about 80%; at least about 85%; at least about 90%; or at least about 94%. Experimental results obtained by the inventors showed that encapsulated E325 in the absence of lyoprotectants showed only 27.8±8.1% survival. In the absence of NaCl, 20% w/v trehalose or 20% w/v maltodextrin cell survivability increased to 44.8±10.6 or 67.3±6.5%, respectively. When 10% w/v trehalose and 10% w/v maltodextrin were used together, survivability increased to 85.5±7.9%. When 0.1 M NaCl was also added to the solution, survivability increased to 93.0±9.6%.

Another aspect of the present invention is survival after a period of storage following lyophilization. Storage is typically carried out in below freezing temperatures, such as, for example, −20° C. Storage may be carried out for 0, 21 and 42 days. Upon storage when a combination of 10% maltodextrin, 10% trehalose, and 0.1 M NaCl, cell survivability increases from 34.2±7.6% after 21 days and 0% after 28 days, to 94.8±2.8% and 73.5±6.7% respectively. In the absence of 0.1 M NaCl survivability was shown to be 89.3±6.1% at 21 days and 64.5±2.8% at 42 days. Therefore, upon rehydration, microorganisms encapsulated within lyoprotected microcapsules of the present invention exhibit a survivability after a freeze drying step and either 21 or 42 days of storage, upon rehydration, of at least about 30%; at least about 35%; at least about 40%; at least about 45%; at least about 50%; at least about 55%; at least about 60%; at least about 65%; at least about 70%; at least about 75%; at least about 80%; at least about 85%; at least about 90%; or at least about 94%.

Therefore, lyoprotected microcapsules of the present invention include wherein a microencapsulation technique is followed by an incubation with the at least one lyoprotective agent to form the lyoprotected microcapsule. The incubation may be in a solution comprising between about 5% and 30% w/v of the at least one lyoprotective agent, or wherein the solution comprises about 10% trehalose (w/v) and about 10% maltodextrin (w/v). The solution may further comprises sodium chloride, which in one embodiment, is between 0.1 M and 0.3 M.

The microorganisms in the lyoprotected microcapsule may exhibit a survival rate of at least about 40%, or at least about 80%. Alternatively, after a freeze-drying step and 21 days of storage at −20 ° C., the microorganisms in the microcapsules may exhibit a survival rate of at least about 80%; and after a freeze-drying step and 42 days of storage at −20 ° C., the microorganisms in the microcapsules exhibit a survival rate of at least about 60%.

The lyoprotective agent(s), without being bound by theory, may permeate the entire capsule or relatively higher concentrations may be found inside the core, inside the core/shell structure, or in the shell of the lyoprotected microcapsule.

The compositions of the invention may comprise additional nutritional additives and components that can help improve and preserve function of the microorganism to allow for improved activity, stability, and release of the microorganism. This may include buffers to stabilize pH, additional lyoprotective agents, such as disaccharides (e.g. glucose, lactose, maltose), bulking agent, salt, tonicity adjusters, such as mannitol, sucrose, glycine, glycerol, PEG and other polyhydric alcohols, amino acids such as glycine, L-serine, alanine, proline, phenylalanine, arginine, proline, sodium chloride, and additional nutrients for improved survival and activity.

The lyoprotected microcapsules may be applied in any manner known for e.g., seed and soil treatment with bacterial strains. The bacterial strain may be homogeneously mixed with one or more compounds or groups of compounds described herein, provided such compound is compatible with bacterial strains. The present invention also relates to methods of treating plants, which comprise application of the bacterial strain, or antifungal compositions containing the bacterial strain, to plants.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a Markush group or other grouping is used herein, all individual members of the group and all combinations and subcombinations possible of the group are intended to be individually included in the disclosure. Specific names of compounds are intended to be exemplary, as it is known that one of ordinary skill in the art can name the same compounds differently.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### EXAMPLES

### Example 1

### Materials and Methods

### Materials

Sodium alginate, Tween 20, sodium citrate, CaCl₂, glycerol, trehalose, and maltodextrin were purchased from Sigma-Aldrich (Milwaukee, Wis., USA). Luria-Bertani (LB) broth and agar were purchased from Fisher Scientific (Waltham, Mass. USA) and BD (Franklin Lakes, N.J., USA), respectively. All chemicals were used without further purification.

### Bacterial Strain and Culture Conditions and Plant Material

P. agglomerans strain E325 was originally isolated from Gala apple blossoms near Wenatchee, Wash., in 1994 [10] and E. amylovora strain Ea153 was obtained from K. Johnson, Oregon State University, Corvallis. E325 and Ea153 are resistant to rifampicin and nalidixic acid, respectively. Strain E325 was transformed with a plasmid carrying the rfp gene (pMP4662) [21]. The rfp gene-labeled E325 (rfp-E325) was used to observe the antagonist on plant tissues ex vivo. The bacteria were stored in 15% glycerol at −70° C. and incubated in LB broth containing 10 g/l tryptone, 5 g/l yeast extract, and 5 g/l sodium chloride in dH2O for 24 h at 28° C. on an orbital shaker at 150 rpm. Cells in the medium were diluted with an alginate solution for microencapsulation. Bacterial levels in the final alginate solution were estimated to be at 1.6×10⁹ colony forming units (CFU) per ml by dilution plating on LB plates at 28° C. for 24 h.

Detached blossoms of apple cultivar Gala (Malus×domestica) were obtained from trees that were induced to bloom in a greenhouse as previously described [10]. Newly opened flowers were collected and maintained by submerging the cut end of the pedicle in 10% sucrose contained in each tube. Tubes with flowers were supported by plastic racks placed in a plastic container. RH was controlled by flooding the bottom of the container, covered with a lid, with varying concentrations of glycerol solution in dH₂O [22].

### Microencapsulation and Moisture Retention of AMC

E325 microencapsulation was performed by the PPF method previously described in U.S. Pat. No. 8,663,511 and also in Kim et al. (2012) “Controlled Release of Pantoea agglomerans E325 for Biocontrol of fire blight disease of apple,” Journal of Controlled Release 161:109-115. Briefly, two 1.0% (w/v) alginate solutions were prepared and filtered through cellulose acetate membranes with pore sizes of 0.8, 0.45, and 0.22 μm, consecutively. 0.5% (w/v) LB broth containing cells was added to one and used as a core solution. The solutions were fed separately into the coaxial nozzle of the PPF system to produce a jet, which was broken up into uniform drops by acoustic excitation. The resulting droplets were gelled in a bath containing 100 mM CaCl₂ and 0.05% (w/v) Tween 20 (pH 7.2-7.4) for 10 min. The resulting AMCs containing E325 were washed three times with sterile water before each experiment. To investigate the moisture retention property of AMC, blank AMCs were placed on polystyrene petri dishes and kept at 25° C. and 20, 40, 60, and 75% RH. The moisture retention of AMCs was calculated by the following equation:

$$Moisture retention ( \% ) = \frac{{W}_{s} - {W}_{d}}{{W}_{i} - {W}_{d}} \times 100$$

where Wₛ is the weight of AMCs at each scheduled time point, Wᵢ the initial weight of AMCs and W_{d} the weight of AMCs dried under vacuum for 24 h.

### In Vitro/Ex Vivo Survivability of Encapsulated E325 at Various Relative Humidities

A total of 18,000 E325-encapsulating AMCs were transferred to each polystyrene dish containing no medium, i.e., 2.36×10⁶ CFU per dish, at 25° C. and 20, 40, 60 and 75% RH. At scheduled time points, the AMCs in each sample were added to 150 mM sodium citrate solution. Initial counts of the encapsulated bacteria were determined immediately after microencapsulation. For ex vivo observation, the E325-encapsulating AMCs suspended in sterile water were applied to Gala apple flowers and incubated at 25° C. and 65% RH. Stigmatic colonization of rfp-E325 released from the AMCs was examined under a fluorescence microscope (Olympus BX51, Olympus America Inc., Waltham, Mass., USA). For quantitative assessment of E325 population, the E325-encapsulating AMCs (1.1×10⁴ CFU/flower) on the apple flowers were incubated at 25° C. and 40, 65 and 90% RH. At scheduled time points, after removing petals, five flowers per treatment were placed in sterile tubes containing a 150 mM sodium citrate solution. Each tube was vortexed and placed in a sonication bath for 1 min. After removing flowers, each tube containing E325 was again vortexed, and serial dilutions were spread on selective media.

### Ex Vivo Assessment of AMC-Mediated Treatment

Naked or encapsulated E325 (10⁴ CFU/flower) was applied to the Gala apple flowers, which were placed in the humidity chambers and incubated at 25° C./40 and 65% RH. After 24 h, strain Ea153 (10⁴ CFU/flower) was applied to the flowers. As controls, naked E325, encapsulated E325, and Ea153 (10⁴ CFU/flower) were separately applied to the flowers. At scheduled time points, five flowers per treatment were sampled to determine each bacterial population size on selective media.

### Lyoprotection and Osmoadaptation of Encapsulated E325 and Long-Term Storage

20% (w/v) trehalose and 20% maltodextrin solutions, and a combination of 10% trehalose and 10% maltodextrin solutions were prepared and sterilized by autoclaving. Each solution was combined with E325-encapsulating AMCs and transferred into sterilized vials (4,500 capsules/vial), kept at −70° C. overnight, and freeze-dried at −50° C. using a Unitop 400 L (Virtis, Pa.) under <1 Pa. The AMCs freeze-dried with no lyoprotectants were prepared as a control. The freeze-dried capsules were rehydrated in DI water at 25° C. for 10 min and liquefied using 150 mM sodium citrate solution. This process was repeated after adding 0.1-0.3 M NaCl to the AMCs with 10% trehalose and 10% maltodextrin solutions. The cell survivability after freeze-drying was calculated as a ratio of the density of the survived cells to the initial cell density. E325 survival in the freeze-dried AMCs, stored at −20 ° C., was measured at scheduled time points of 0, 3, 7, 14, 21, 28 and 42 days. The cell density survived from freeze-drying was set as 100% survival for each data set.

### Statistical Analysis

Data are expressed as mean values ±SD of n independent observations. Data comparisons were performed by one-way ANOVA and paired two-tailed Student's t tests in case of multiple comparisons. Differences with p<0.05 were considered statistically significant.

### Example 2

### Microencapsulation

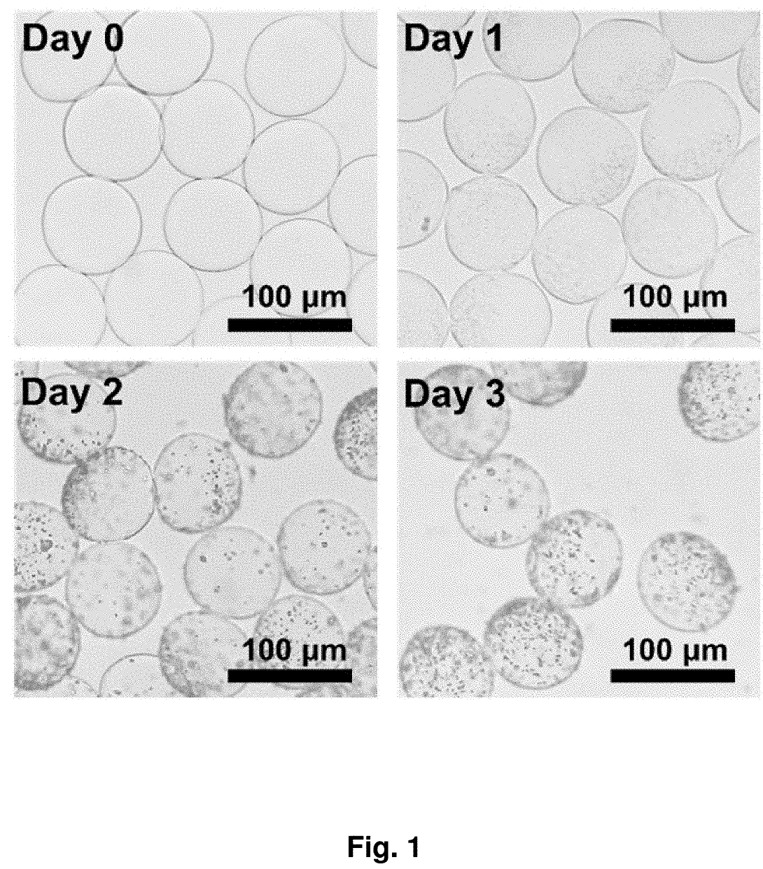

AMCs 80 μm in diameter were employed to encapsulate E325. The capsule size was selected to effortlessly cover the main target sites, i.e., the stigmatic (<1 mm²) and hypanthial (2-3 mm²) surfaces of flower. FIG. 1 shows the optical images of the E325-encapsulating AMCs prepared by the PPF method, illustrating that the E325 cells multiply in the capsules as a function of time.

### Example 3

### Moisture Retention of AMCs and In Vitro Survivability of Encapsulated E325 at Various RH

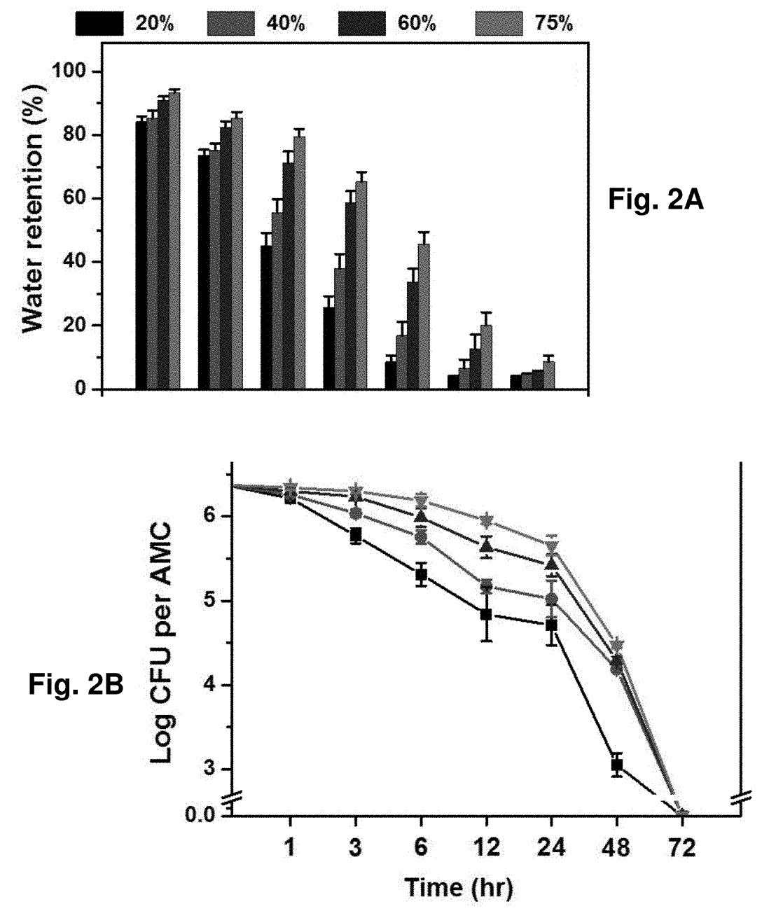

FIG. 2(a) shows the water retention property of the AMCs at 25° C./20, 40, 60 and 75% RH, displaying that the evaporation of water from the AMCs increased with decreasing RH during the 3-day period. At 20 and 75% RH, the water retention after 12 h was <30 and 65%, respectively, and after 24 h, 10 and 50%, respectively. Under all RH conditions, 90-95% water was evaporated from the AMCs after 72 h. FIG. 2(b) shows the survival of E325, i.e., the sum of cells released from and remaining in the AMCs, as a function of time under different RH conditions. The E325 survival decreased with decreasing RH that was associated with the water retentivity of the AMCs. However, under all RH conditions, the encapsulated E325 maintained a population size of ˜10⁵ CFU/AMC for 1 day, exhibiting the positive effect of AMCs on the survival of E325. It was intriguing that the encapsulated cells exhibited a meaningful survivability even at 20% RH for 2 days.

### Example 4

### Ex Vivo Survivability of Encapsulated E325

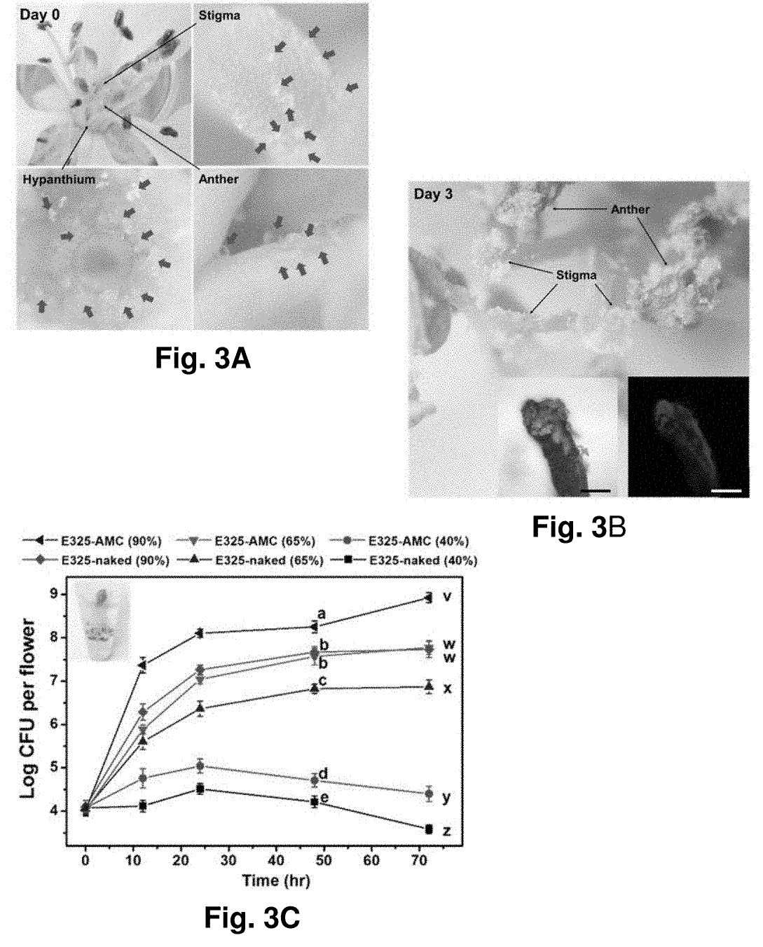

FIG. 3(a) shows the optical images of detached blossoms of Gala apple immediately after applying the AMCs encapsulating rfp-E325, and FIG. 3(b) the optical and fluorescence images taken after 3 days of incubation at 65% RH. FIG. 3(a) reveals the AMCs landed on the surfaces of stigmata, anthers and hypanthium. FIG. 3(b) shows that the capsules on stigmata and anthers shrank and became yellowish in color after 3 days, indicating water evaporation from the capsules. The fluorescence image of the stigma shows that the cells proliferated inside the capsules and egressed to cover its surface [20, 21]. FIG. 3(c) shows the survival of naked E325 (E325-naked) and E325 encapsulated in AMCs (E325-AMCs) applied on the floral surfaces of Gala apple at 25° C./40, 65 and 90% RH, with an initial population size of 10⁴ CFU/flower. At 90% RH, the population sizes of both E325-naked and E325-AMCs increased drastically during the initial 24 h. In particular, the growth of E325-AMCs was so large that their population after 24 and 72 h reached 10⁸ and 10⁹ CFU/flower, respectively. At 65% RH, the growth of E325-AMCs was still fast, which was comparable to that of E325-naked at 90% RH, while that of E325-naked slowed down. At 40% RH, the growth of E325-AMCs was slow during the 24 h period. After 24 h, the population size declined, reaching 10⁴ CFU/flower at 72 h. E325-naked exhibited no meaningful growth but a decrease after 24 h to a population size of 10³ CFU/flower at 72 h. Under all RH conditions, E325-AMCs exhibited higher populations than E325-naked at each time point.

### Example 5

### Ex Vivo Assessment of AMC-Mediated Treatment

To investigate the suppressive activity of E325-naked and E325-AMC, Ea153 was applied to detached Gala apple blossoms that had been inoculated with each type of E325 and incubated for 24 h. FIG. 4 shows the changes in the populations of E325-naked and E325-AMC over 72 h after application of Ea153 and their suppressive activity against Ea153. As shown in FIGS. 4(a) and (b), the population sizes of E325-naked, E325-AMC, and Ea153 increased during the initial 24 h when incubated at 25° C./65 and 40% RH, and thereafter remained relatively constant at 65% RH but decreased at 40% RH. At both 65 and 40% RH, the population sizes of E325-AMC were greater than those of E325-naked with or without the application of Ea153. At 65% RH, the population sizes of both E325-naked and E325-AMC increased with time regardless of the Ea153 application, and the difference between the E325 population size with and without Ea153 application was small during the 72-h period. At 40% RH, the difference was larger and became quite substantial at 72 h. However, after the Ea153 application, the population of E325-AMC remained close to the initially inoculated size while E325-naked exhibited a significant reduction. FIGS. 4(c) and 4(d) show the effect of E325-AMC or E325-naked on the population size of Ea153, indicating that E325-AMC suppressed the growth of Ea153 population more effectively than E325-naked during the period from 36 (or 12 h after inoculation with Ea153) to 72 h. As expected from its high survivability seen in FIG. 4(b), at 40% RH, E325-AMC exhibited high suppressive activity, lowering the population of Ea153 below 10³ CFU/flower after 72 h.

### Example 6

### Survival of Encapsulated E325 During Lyophilization

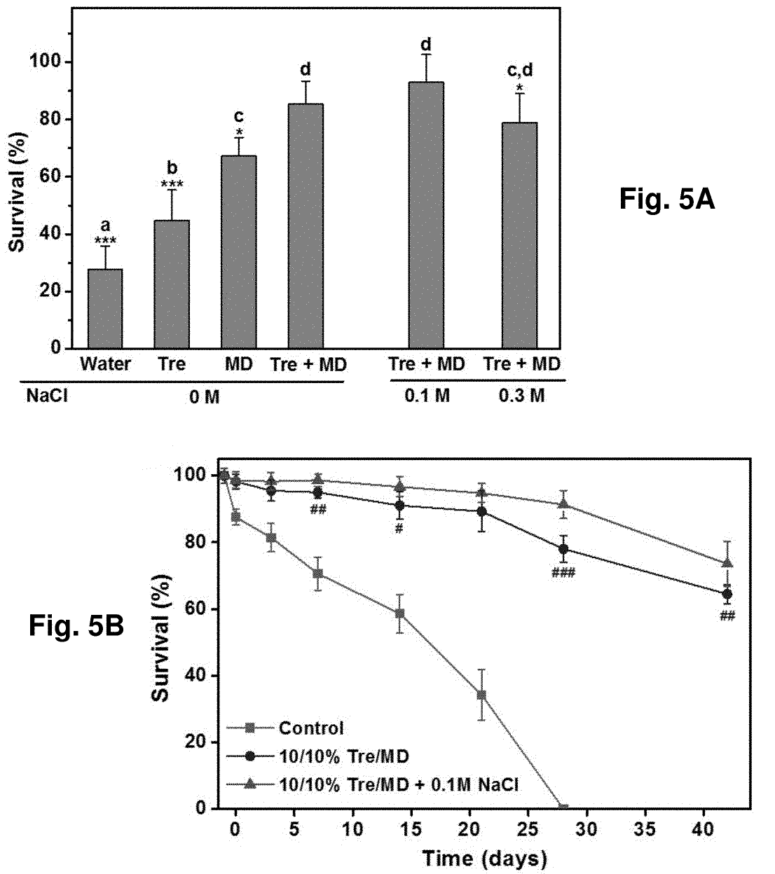

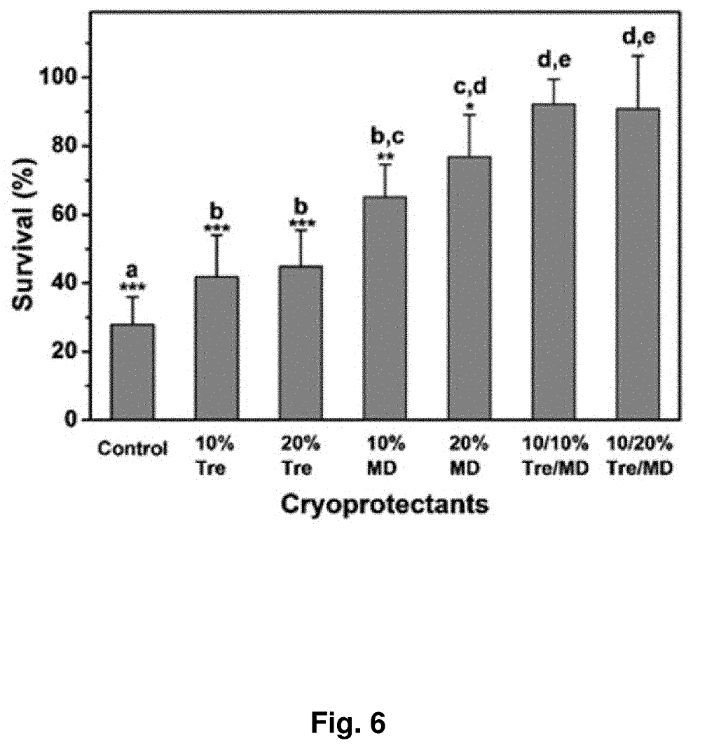

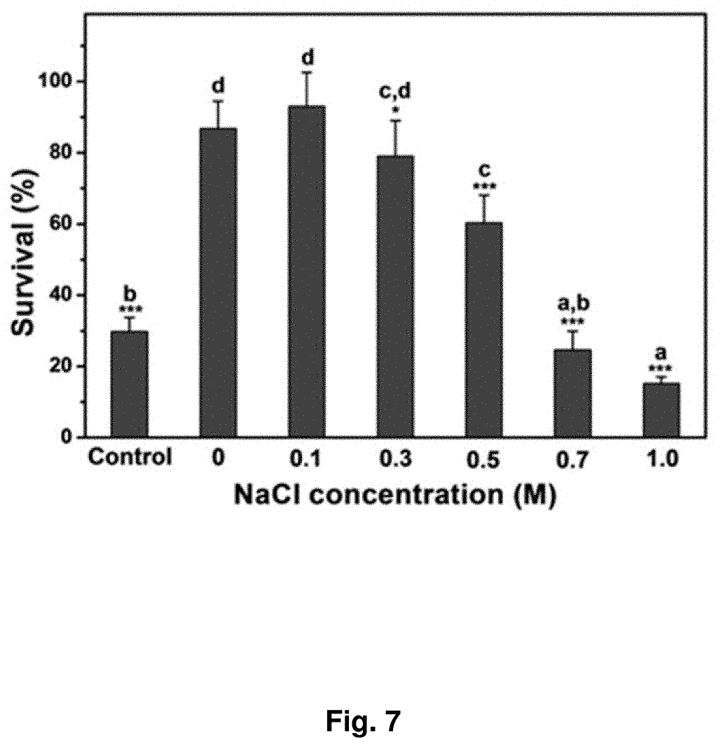

Lyophilization is considered to be the most efficient method to maintain cell viability during storage [23]. However, when the E325-encapsulating AMCs were lyophilized without any lyoprotectants, the survival of the E325 cells reduced to 27.8±8.1%. FIG. 5(a) shows the effect of trehalose and maltodextrin (MD), used as lyoprotectants, on the survival of the E325 cells during freeze-drying. In the absence of NaCl, by incorporating 20% (w/v) trehalose or MD the cell survivability increased to 44.8±10.6 or 67.3±6.5%, respectively. The increase was more significant when 10% trehalose and 10% MD were used together, resulting in 85.5±7.9% survivability. When 0.1 M NaCl was used with the trehalose and MD mixture, the cells exhibited 93.0±9.6% survivability. However, these two values showed no statistically significant difference. As the concentration of NaCl increased to 0.3M, the survivability decreased. FIG. 5(b) illustrates the survivability of the AMC-encapsulated E325, freeze-dried and stored at −20° C. for 42 days. The survivability of the cells lyophilized without the lyoprotectants decreased to 34.2±7.6% after storing for 21 days and 0% for 28 days. When the lyoprotectants were incorporated with 0.1 M NaCl, the cell survivability after 21 and 42 days of storage was 94.8±2.8 and 73.5±6.7%, respectively, and without NaCl, 89.3±6.1 and 64.5±2.8%, respectively.

The tree invasion of Ea starts with colonization on the flower surfaces during petal expansion which typically lasts 3 to 4 days. A moisture- and nutrient-rich environment of stigmatic papillae allows bacterial cells to colonize even under arid climatic conditions. Rain or heavy dew facilitates the cell movement along the floral style toward the nectarthodes of hypanthium, the main infection site of fire blight [18]. Therefore, an important prerequisite for antagonists to act effectively against pathogens would be their tolerance to abiotic factors such as temperature, water availability, and RH. But, on a typical spring daytime when temperature rises and RH decreases, antagonists landing on floral surfaces excluding stigmas, e.g., hypanthium, anthers and petals, are subject to desiccation. In this study, due to the highly hydratable nature of the alginate matrix, the AMCs exhibited excellent water retention properties under various RH conditions (FIG. 2(a)) [24], allowing the survival of the encapsulated E325 for >2 days even at 20% RH (FIG. 2(b)). This implies that the AMCs could prolong the survivability of E324 landing on moisture-poor surfaces of the flower. The maximum population size of bacterial strains, such as A506, C9-1 and Ea153, in the detached Gala apple blossoms was reported to be between 10⁶ and 10⁷ CFU/flower [10]. The increase in the population sizes to over 10⁷ CFU/flower at >65% RH indicated that the E325 cells would continuously multiply in the AMCs and be released to colonize the floral surfaces (FIGS. 3(b) and 3(c)). This shows that AMCs served as micro-incubators and supply-depots to provide water and nutrients to the antagonist.

### REFERENCES

[1] J. P. Paulin, Control of fireblight in European pome fruits, Outlook on Agriculture, 25 (1996) 49-55.

[2] W. Denning, On the decay of apple trees, NY Soc Prom Agric Arts Manuf Trans, 2 (1794) 219-222.

[3] G. W. Bonn, T. van der Zwet, Distribution and economic importance of fire blight, in: J. L. Vanneste (Ed.) Fire blight the disease and its causative agent, Erwinia amylovora, CABI Publishing, Wallingford, UK, 2000, pp. 37-54.

[4] S. Jock, A. Wensing, J. Pulawska, N. Drenova, T. Dreo, K. Geider, Molecular analyses of Erwinia amylovora strains isolated in Russia, Poland, Slovenia and Austria describing further spread of fire blight in Europe, Microbiological Research, 168 (2013) 447-454.

[5] P. S. McManus, A. L. Jones, Epidemiology and genetic analysis of streptomycin resistant Erwinia amylovora from Michigan and evaluation of oxytetracycline for control, Phytopathology, 84 (1994) 627-633.

[6] W. J. Moller, M. N. Schroth, S. V. Thomson, The Scenario of Fire Blight and Streptomycin Resistance, Plant Disease, 65 (1981) 563-568.

[7] P. S. McManus, V. O. Stockwell, G. W. Sundin, A. L. Jones, Antibiotic use in plant agriculture, Annual Review of Phytopathology, 40 (2002) 443-+.

[8] H. A. S. Epton, M. Wilson, S. L. Nicholson, D. C. Sigee, Biological control of Erwinia amylovora with Erwinia herbicola, in: J. P. Blakeman, B. Williamson (Eds.) Ecology of Plant Pathogens, CAB International, Wallingford, UK, 1994, pp. 335-352

[9] S. E. Lindow, Integrated control and role of antibiosis in biological control of fire blight and frost injury, in: C. Windels, S. E. Lindow (Eds.) Biological Control on the Phylloplane, The American Phytopathological Society, St. Paul, Minn., USA, 1984, pp. 83-115

[10] P. L. Pusey, Crab apple blossoms as a model for research on biological control of fire blight, Phytopathology, 87 (1997) 1096-1102.

[11] C. A. Ishimaru, E. J. Klos, R. R. Brubaker, Multiple Antibiotic Production by Erwinia-Herbicola, Phytopathology, 78 (1988) 746-750.

[12] K. B. Johnson, V. O. Stockwell, R. J. Mclaughlin, D. Sugar, J. E. Loper, R. G. Roberts, Effect of Antagonistic Bacteria on Establishment of Honey Bee-Dispersed Erwinia-Amylovora in Pear Blossoms and on Fire Blight Control, Phytopathology, 83 (1993) 995-1002.

[13] M. Wilson, H. A. S. Epton, D. C. Sigee, Interactions between Erwinia-Herbicola and E-Amylovora on the Stigma of Hawthorn Blossoms, Phytopathology, 82 (1992) 914-918.

[14] P. Pusey, V. O. Stockwell, C. L. Reardon, T. H. Smits, B. Duffy, Antibiosis by Pantoea agglomerans biocontrol strain E325 against Erwinia amylovora on apple flower stigmas, Phytopathology, 101 (2011) S146-S147.

[15] P. Pusey, V. O. Stockwell, D. R. Rudell, Antibiosis and acidification by Pantoea agglomerans strain E325 may contribute to suppression of Erwinia amylovora, Phytopathology, 98 (2008) 5128-5128.

[16] C. Leben, Relative-Humidity and the Survival of Epiphytic Bacteria with Buds and Leaves of Cucumber Plants, Phytopathology, 78 (1988) 179-185.

[17] P. L. Pusey, E. A. Curry, Temperature and pomaceous flower age related to colonization by Erwinia amylovora and antagonists, Phytopathology, 94 (2004) 901-911.

[18] S. V. Thomson, The Role of the Stigma in Fire Blight Infections, Phytopathology, 76 (1986) 476-482.

[19] S. V. Thomson, M. N. Schroth, W. J. Moller, W. O. Reil, Occurrence of fire blight of pear in relation to weather and epiphytic populations of Erwinia amylovora, Phytopathology, 65 (1975) 576-579.

[20] I. Y. Kim, P. L. Pusey, Y. Zhao, S. S. Korban, H. Choi, K. K. Kim, Controlled release of Pantoea agglomerans E325 for biocontrol of fire blight disease of apple, J Control Release, 161 (2012) 109-115.

[21] G. V. Bloemberg, A. H. Wijfjes, G. E. Lamers, N. Stuurman, B. J. Lugtenberg, Simultaneous imaging of Pseudomonas fluorescens WCS365 populations expressing three different autofluorescent proteins in the rhizosphere: new perspectives for studying microbial communities, Molecular plant-microbe interactions: MPMI, 13 (2000) 1170-1176.

[22] C. G. Johnson, The maintenance of high atmospheric humidities for entomological work with glycerol-water mixtures, Ann. Appl. Biol., 27 (1940) 295-297.

[23] E. Montesinos, Development, registration and commercialization of microbial pesticides for plant protection, International microbiology: the official journal of the Spanish Society for Microbiology, 6 (2003) 245-252.

[24] I. Y. Kim, M. K. Yoo, J. H. Seo, S. S. Park, H. S. Na, H. C. Lee, S. K. Kim, C. S. Cho, Evaluation of semi-interpenetrating polymer networks composed of chitosan and poloxamer for wound dressing application, Int J Pharm, 341 (2007) 35-43.

[25] V. O. Stockwell, K. B. Johnson, V. W. Johnson, Colonization of flowers by Pseudomonas fluorescens A506 formulated in a biopolymer gel, Acta hort. (ISHS), 704 (2006) 293-300.

[26] C. P. Champagne, F. Mondou, Y. Raymond, D. Roy, Effect of polymers and storage temperature on the stability of freeze-dried lactic acid bacteria, Food research international, 29 (1996) 555-562.

[27] E. Costa, J. Usall, N. Teixido, N. Garcia, I. Vinas, Effect of protective agents, rehydration media and initial cell concentration on viability of Pantoea agglomerans strain CPA-2 subjected to freeze-drying, J Appl Microbiol, 89 (2000) 793-800.

[28] J. Cabrefiga, J. Frances, E. Montesinos, A. Bonaterra, Improvement of a dry formulation of Pseudomonas fluorescens EPS62e for fire blight disease biocontrol by combination of culture osmoadaptation with a freeze-drying lyoprotectant, Journal of applied microbiology, 117 (2014) 1122-1131.

[29] Y. Bashan, Inoculants of Plant Growth-Promoting Bacteria for Use in Agriculture, Biotechnol. Adv., 16 (1998) 729-770.

[30] T. Huq, A. Khan, R. A. Khan, B. Riedl, M. Lacroix, Encapsulation of Probiotic Bacteria in Biopolymeric System, Crit Rev Food Sci Nutr, 53 (2013) 909-916.

[31] L. Kearney, M. Upton, A. McLoughlin, Enhancing the viability of Lactobacillus-Plantarum inoculum by immobilizing the cells in calcium-alginate beads incorporating cryoprotectants, Appl Environ Microb, 56 (1990) 3112-3116.

[32] E. Paul, J. Fages, P. Blanc, G. Goma, A. Pareilleux, Survival of Alginate-Entrapped Cells of Azospirillum lipoferum During Dehydration and Storage in Relation to Water Properties, Appl. Microbiol. Biotechnol., 40 (1993) 34-39.

[33] D. Dianawati, V. Mishra, N. P. Shah, Survival of Bifidobacterium longum 1941 microencapsulated with proteins and sugars after freezing and freeze drying, Food research international, 51 (2013) 503-509.

[34] L. Hamoudi, J. Goulet, C. Ratti, Effect of protective agents on the viability of geotrichum candidum during freeze-drying and storage, Journal of food science, 72 (2007) M45-49.

[35] S. Strasser, M. Neureiter, M. Geppl, R. Braun, H. Danner, Influence of lyophilization, fluidized bed drying, addition of protectants, and storage on the viability of lactic acid bacteria, J Appl Microbiol, 107 (2009) 167-177.

[36] L. N. Csonka, A. D. Hanson, Prokaryotic osmoregulation: genetics and physiology, Annu Rev Microbiol, 45 (1991) 569-606.

[37] E. A. Galinski, Osmoadaptation in bacteria, Adv Microb Physiol, 37 (1995) 272-328.

[38] A. Bonaterra, J. Camps, E. Montesinos, Osmotically induced trehalose and glycine betaine accumulation improves tolerance to desiccation, survival and efficacy of the postharvest biocontrol agent Pantoea agglomerans EPS125, FEMS microbiology letters, 250 (2005) 1-8.

[39] A. Bonaterra, J. Cabrefiga, J. Camps, E. Montesinos, Increasing survival and efficacy of a bacterial biocontrol agent of fire blight of rosaceous plants by means of osmoadaptation, FEMS Microbiol Ecol, 61 (2007) 185-195.

1. A lyoprotected microcapsule for extending the storage viability of a live microorganism, comprising:
an interior core comprising at least one live microorganism; a first polymer; and at least one nutrient;
an exterior shell comprising a second polymer; and
at least one lyoprotective agent; and
wherein the live microorganism in the lyoprotected microcapsule has extended storage viability compared to a microorganism in a microcapsule in the absence of the at least one lyoprotective agent.

2. The lyoprotected microcapsule of claim 1, wherein the first and second polymer are independently selected from the group consisting of alginate, ethyl cellulose, polyvinyl alcohol, hyaluronic acid, chitosan, agarose, hydroxypropyl methylcellulose, polyvinyl alcohol copolymer, polyethylene glycol, and gelatin.

3. The lyoprotected microcapsule of claim 3, wherein the first polymer and the second polymer are alginate.

4. The lyoprotected microcapsule of claim 1, wherein the microorganism is selected from Pantoea agglomerans strains C9-1 and E325, Bacillus subtilis BD170, Lactobacillus plantarum strains PC40, PM411, TC54 and TC92, P. fluorescens strain A506, Lactobacillus plantarum SLG17 and Bacillus amyloliquefaciens FNL13.

5. The lyoprotected microcapsule of claim 1, wherein the microorganism is P. agglomerans strain E325.

6. The lyoprotected microcapsule of claim 1, wherein the at least one lyoprotective agent is selected from the group consisting of sucrose, glucose, galactose, maltose, maltotriose, maltodextrin, trehalose, mannitol, sorbitol, lactose, glycerol, xylitol, inositol, oligosaccharides, dextrans, and combinations thereof.

7. The lyoprotected microcapsule of claim 1, wherein the at least one lyoprotective agent is a combination of trehalose and maltodextrin.

8. The lyoprotected microcapsule of claim 1, wherein the microcapsule is formed by a process comprising a microencapsulation technique comprising a vibrational nozzle technique and the microcapsule has dimensions of between 60 μm and 300 μm.

9. (canceled)

10. The lyoprotected microcapsule of claim 8, wherein the interior core is formed by spraying a mixture comprising the microorganism at a concentration of between 0.1×10⁹ and 10×10⁹ cfu/ml, the at least one nutrient, and the polymer, wherein the polymer comprises alginate at 0.8% to 2.0% (w/v), through a vibrational nozzle, and wherein the exterior shell is formed by simultaneously spraying an alginate solution which has been filtered through a membrane through a vibrational nozzle.

11. (canceled)

12. The lyoprotected microcapsule of claim 10, wherein the alginate solution has been filtered through a 1 to 0.1 micron filter, and the alginate solution is at between about 5% and 0.5% (w/v).

13. The lyoprotected microcapsule of claim 12, wherein the filter is selected from a 0.8 micron, a 0.45 micron, or a 0.22 micron filter, and the alginate solution is 1.0% (w/v), 1.2% (w/v), 1.5% (w/v), or 2.0% (w/v).

14. (canceled)

15. The lyoprotected microcapsule of claim 8 wherein the microencapsulation technique is followed by an incubation with the at least one lyoprotective agent to form the microcapsule, and wherein the incubation is in a solution comprising between about 5% and 30% w/v of the at least one lyoprotective agent.

16. (canceled)

17. The lyoprotected microcapsule of claim 15, wherein the solution comprises about 10% trehalose (w/v), about 10% maltodextrin (w/v), and sodium chloride between 0.1 M and 0.3 M.

18-21. (canceled)

22. The lyoprotected microcapsule of claim 1, wherein after a freeze-drying step, upon rehydration, the microorganisms in the microcapsules exhibit a survival rate of at least about 80%.

23. (canceled)

24. The lyoprotected microcapsule of claim 1, wherein after a freeze-drying step and 21 days of storage at −20° C., the microorganisms in the microcapsules exhibit a survival rate of at least about 80%.

25. The lyoprotected microcapsule of claim 1, wherein after a freeze-drying step and 42 days of storage at −20° C., the microorganisms in the microcapsules exhibit a survival rate of at least about 60%.

26. (canceled)

27. A method for producing a lyoprotected microcapsule providing extended storage viability for a live microorganism, comprising:
a) encapsulating a live microorganism within an interior core comprising a first polymer and at least one nutrient; and an exterior shell comprising a second polymer to form an encapsulated live microorganism;
b) contacting the encapsulated live microorganism with a solution comprising at least one lyoprotective agent to form the lyoprotected microcapsule,
wherein the lyoprotected microcapsule provides the microorganism with an extended storage viability compared to a microorganism in a microcapsule in the absence of the at least one lyoprotective agent.

28-51. (canceled)

52. A method for the treatment or prophylactic prevention of a disease in a plant, the method comprising treating a plant with a therapeutic amount of the lyoprotected microcapsules of claim 1.

53. (canceled)

54. The method of claim 52, wherein the disease is fire blight.

55. (canceled)
